(19) United States
(12) Patent Application Publication
(10) Pub. No.: US 2008/0044232 A1
(43) Pub. Date: Feb. 21, 2008

(54) Method of Operating a Sheeting Machine for Laying Pipes,and Sheeting Machine

(75) Inventor: Manfred Lauscher, Monschau Rohren (DE)

Correspondence Address: LERNER GREENBERG STEMER LLP, P O BOX 2480, HOLLYWOOD, FL, 33022-2480, US

(73) Assignees: Lauscher Manfred; Pipe Train International Ltd.

(21) Appl. No.: 11/665,479

(22) PCT Filed: Oct. 14, 2004
(86) PCT No.: PCT/EP04/11543

§ 371 Date: Apr. 16, 2007

(51) Int. Cl. F16L 1/036; E03F 3/06

(52) U.S. Cl. 405/155; 405/184.5

(57) ABSTRACT

A sheeting machine is formulated for laying pipes in earth. In order to ensure that the laying can be automated to a greater degree and that the sheeting machine is at the same time operated in such a way that damage to the machine is avoided, the feed forces or the hydraulic pressures, necessary for advancement, of the working cylinders disposed on a cutting shoe and inside the sheeting are measured and are recorded in relation to a installation position of each working cylinder. The pressures between the left-hand and the right-hand sheeting side are compared, and that, in the event of asymmetry outside a predeterminable tolerance, either the advance movement of the sheeting machine is automatically stopped or correction control is automatically initiated.

The invention relates to a method for operating a sheeting machine for laying pipes, and to a sheeting machine, according to the preamble of patent claims 1 and 7.

Methods and apparatuses of this type are used for laying sewage pipes, but also for pipes of another type. In older construction measures, work is carried out at an open shaft. This means that, for example in a construction zone to be developed, a corresponding trench several meters deep has to be dug by means of an excavator, the trench being formed so as to widen toward the top in a funnel shape, and the inclination of the side faces resulting from the condition of the subsoil and from the natural slope resulting therefrom. Overall, a trench is produced which, at a total depth of 3 m, can already measure more than 8 m in width. Such a laying method is referred to in technical terminology as laying at the open shaft.

For this reason, it is also known to carry out work at a half-open shaft, the side flanks of the shaft being fixed with “sheeting panels”. A markedly narrower trench is thus produced.

Furthermore, it is known to produce a narrow trench, possibly narrower than the pipe diameter to be laid, and secured with sheeting panels and to jack the pipes under the trench into the earth by means of a driving jack under the region secured with sheeting panels. In the last-mentioned case, and also during the entirely closed pipe advance, only stationary jacking stations in the “starting pit” are of course used, where new pipes are also inserted after every advance stroke.

An old method is known from DE 26 03 565 C2. In this case, the driving jack and the driving tool are placed in a foundation pit, the “starting pit”. Here, the driving jack is hydraulically actuated on account of the enormous forces that occur. A jack, a pressure-compensating ring and also sliding rails and pressure-compensating devices are mounted here in the starting pit, the entire jack arrangement therefore being installed there in a stationary position. Furthermore, a driving tool in accordance with the abovementioned cutting shoe is thrust forward. If the length of a conduit pipe to be laid is achieved with such a cutting stroke, the driving jack is moved back in the opposite direction, and a conduit pipe is lowered from above between driving jack and cutting shoe. After that, the driving jack is extended again, in the course of which the inserted conduit pipe and the cutting shoe are driven forward. After achieving a further conduit pipe length, the driving jack is retracted again and the next conduit pipe to be laid is inserted from above. As already described above, the accumulating displaced earth is removed at the surface by an excavating apparatus, generally by an excavator.

Experience shows that enormous sliding friction forces occur at the already laid pipe section after a distance of 100-200 m, because the driving jack has to feed an ever increasing total pipe length. The possible maximum laying lengths are reached after said 100-200 m. There is also an enormous pressure load on the conduit pipe laid last in each case, which must be absorbed by the effective forces which push forward the entire conduit pipe already laid. Basically not all manufacturers of conduit pipes allow such a strength that makes this possible.

Furthermore, it is known from DE 42 41 856 that the driving jack follows on, to be precise in such a way that the pipe laid last is used as an abutment for the driving jack in order to push forward a further pipe section or a further conduit pipe.

In principle, the disadvantage that an enormous force is exerted on the pipes in the axial direction likewise occurs here.

In order to remove this disadvantage, a method and an apparatus according to DE 101 00 777 A1 have been provided with which both the cutting head and the sheeting can be displaced in the laying direction by a laying and sheeting machine. The sheeting cuts forward in exactly the same way as the cutting head with the laid pipe. In this case, the sheeting panels can not only be moved forward and can thus cut into the earth, but they can also be spread when stationary, such that the pipe advance distributes its abutment forces partly to the sheeting panels and partly to earth poured in again at the rear and compacted, and only a small proportion of said abutment forces is distributed to the pipe section already laid. In this case, unlike in the other prior art, the laid pipe is subjected to much lower stress.

Based on said prior art, which is already advantageous per se, the object of the present invention is to improve a method and an apparatus of the generic type to the effect that the laying can be automated to a greater degree, and at the same time the apparatus can be operated in such a way that damage to the apparatus is avoided.

The stated object is achieved in a method of the generic type by the characterizing features of patent claim 1.

Further advantageous configurations of the method according to the invention are specified in dependent method claims 2 to 6.

With regard to the apparatus of the generic type, the stated object is achieved according to the invention by the characterizing features of patent claim 7.

Further advantageous configurations in this respect are specified in the remaining dependent apparatus claims.

The essence of the invention with respect to the method is that the feed forces or the hydraulic pressures, necessary for the advance, of the working cylinders arranged on the cutting shoe and inside the sheeting are measured and are recorded in relation to the installation position of each working cylinder, and the pressures between the left-hand and the right-hand sheeting side are compared, and that, in the event of asymmetry outside a predeterminable tolerance, the advance movement of the sheeting machine is automatically stopped or there is an automatic intervention in the control of the cutting shoe jack and/or of the sheeting advance, or correction control is automatically initiated.

That is to say that the control movements of cutting shoe and sheeting are always matched to one another. The cutting shoe and the sheeting are certainly controlled separately and each individually, but both are at the same time controlled in one and the same target direction. The cutting shoe certainly moves during the advance together with the sheeting, but both move independently of one another. The result of this is that maloperation or changes in earth density can lead to a deviation between cutting shoe movement and sheeting movement. Precisely this divergence produces in turn, in the manner according to the invention, a divergence in the location signals determined. If this is detected, the control system is immediately operated with control correction, or, in the extreme case, if the deviation can no longer be modulated, the sheeting machine is automatically stopped. In a further advantageous configuration, provision is made for the density asymmetry in the earth during the advance to be determined by a correlation of hydraulic pressure measurement and displacement measurement in such a way that operating forces optimized as a result are determined and modulated for the respective working cylinders of the cutting shoe and of the sheeting.

In a further configuration, provision is made, inside the sheeting, for it to be possible for a cutting shoe for cutting the following pipe contour on the base side to be controlled both together with the sheeting and independently of the latter.

Transversely running obstacles can already be detected from a predeterminable distance from the sheeting machine by means of sensors at the advance-side tip of the sheeting, and the sheeting machine is thereupon stopped automatically.

Of considerable advantage is a configuration in which two pipes lying one above the other are laid by the bottom pipe being inserted into the space between pressure and thrust plate and the compacting plate up to the pipe possibly already laid beforehand and by the top pipe being inserted directly above the first pipe up to the top pipe possibly laid beforehand, and by the earth that is poured in again first of all being pushed together around the bottom pipe by means of a bottom compacting plate and then by the earth being pushed together around and above the top laid pipe by means of a top compacting plate. In this case, the two pipes are inserted side by side and are then taken into account in a respective common stroke of pressure and thrust plate and the compacting plate.

It is especially advantageous in this case that the monitoring of the hydraulic control forces/control pressures, which to an evaluation of the still feasible cutting process as a function of the geological findings, is intended to effect automatic correction control or to shut off the machine in the event of overload, together with the fact that the cylinder arrangement according to the invention is placed in such a way that considerably higher forces can be applied, before plastic distortions occur at the sheeting machine. By the cylinders being integrated according to the invention in the sheeting panels, instead of the latter being mounted on angles of the same, considerably higher advance forces can be applied to the sheeting, which of course is now also to be advanced. If the cylinders were fixed to welded angles, forces perpendicular to the desired feed forces parallel to the sheeting panels would also occur in addition to said feed forces during the force initiation. Said bending forces are completely removed by the integration according to the invention in the sheeting panels and therefore no longer represent any locations at risk of bending fracture when the enormous pushing forces are applied.

Owing to the fact that larger forces can now be applied to the sheeting panels to be pushed, and therefore the cutting and laying process can now also be carried out in firmer, denser earth, it is especially important that the limit loading capacities of the material are maintained or can be automatically maintained in a comfortable and self-controlling manner. If dense obstacles on account of rock fragments or sudden increases in density in the earth are now detected in this functional combination by the cylinder pressures being monitored in the described manner according to the invention, in particular with regard to force or pressure asymmetry, automatic shut-off is effected before overloading, or automatic correction control intervention is effected if feasible.

Here, not only is the fact important that the earth along the laying section can turn out to be increasingly denser, which of course can also easily lead to a symmetrical pressure increase, and not to an asymmetrical pressure increase. Automatic shut-off is then also generated in such a case. Rather, such cases are still critical where the laying and sheeting machine according to the invention moves through earth which is harder or denser on the left-hand side of the sheeting panel than on the right-hand side of the sheeting panel. The cutting shoe, which cuts half the pipe contour, i.e. the bottom pipe contour, may also be loaded differently on account of different earth conditions and as a result may be subjected to different forces from the sheeting above it. Such a case would produce enormously high bending forces on the laying and sheeting machine and on the connecting parts between cutting shoe jack and sheeting, and these bending forces can subject the statics of the sheeting machine of linked construction and of the connecting parts to high stress and indeed may even damage them. Such asymmetry is automatically detected by the procedure according to the invention and by the apparatus according to the invention, and the machine is stopped or automatic correction control starts, and from then on, after automatic shut-off, only careful manual movement may be carried out until the asymmetry is again within a predetermined or predeterminable tolerance range.

The further configurations relate to those details which assist the automatic advance process desired according to the invention, while automatically taking into account mechanical limit loads.

Thus, in a further advantageous configuration, the mobility of the cutting shoe jack relative to the sheeting is locked. The cutting shoe jack is then moved together with the sheeting. With this operating option, the entire sheeting together with the cutting shoe jack is moved. In many operating options, it is advantageous to be able to advance the cutting shoe jack and the sheeting individually. For example, if a cutting shoe jack extended beforehand is hauled in again by the sheeting feed, this sheeting, via the fastening parts to the cutting shoe jack, must inevitably follow the movements and thus the course of the cutting shoe. If the sheeting is advanced and the cutting shoe jack follows the sheeting, the cutting shoe jack likewise inevitably has to follow the sheeting via the connecting parts. The additional control of the cutting shoe itself is not affected by this.

It is also advantageous that the cutting shoe jack, by extension in the Z direction, according to the drawing, transmits the pressure to the cutting shoe tip and/or to the sheeting and via the pressure and thrust plate to the pipes possibly already laid beforehand, but at the same time also acts as an abutment and as stabilization for the working cylinders of the compacting plate. During locking to the sheeting, the forces of the cutting shoe jack act on the advancing movement of the entire machine.

If the sheeting is unlocked from the cutting shoe jack, the advance forces act in the Y direction and press only the cutting shoe into the earth.

Structurally, i.e. in relation to the apparatus, the essence of the invention lies in the fact that the feed forces or the hydraulic pressures, necessary for the advance, of the working cylinders arranged on the cutting shoe and inside the sheeting are measured via sensors and are recorded electronically in a control device in relation to the installation position of each working cylinder, and the pressures between the left-hand and the right-hand sheeting side are compared, and that, in the event of asymmetry outside a predeterminable tolerance, either the advance movement of the sheeting machine is automatically stopped or correction control of said advance movement is effected. The apparatus is configured in such a way that the density asymmetry in the earth during the advance is calculated by a correlation of hydraulic pressure measurement and displacement measurement inside the control system, and the displacement measurement is effected via optical, resistive or acoustic sensors.

A further advantageous configuration consists in the fact that at least one hydraulically movable pressure and thrust plate for the partial abutting support during the advance on the already laid pipe section is arranged inside the sheeting machine, said pressure and thrust plate(s) being movable forward and backward inside the sheeting machine via working cylinders inside the sheeting.

For the suitable draining or passage of water, provision is made for a bulkhead partition which can be opened to be integrated inside the thrust/compacting plate. This is advantageous if, for example, the novel apparatus has to travel over sewers in operation and the latter have to be exchanged. By opening the bulkhead partition, the waste water can be directed through the cutting shoe and the cutting shoe jack and can be drawn off again through the new pipes already laid. It is thus no longer necessary to shut off or pump over the water.

A bulkhead partition which can be opened is likewise integrated inside the thrust/compacting plate.

In a further advantageous configuration, provision is made for at least some of the working cylinders to be arranged so as to be integrated inside the sheeting panel wall in the sheeting machine. In this case, however, all the working cylinders moving the sheeting and also moving the compacting plate and the thrust plate are integrated inside the sheeting panels. There are therefore no longer any working cylinders getting in the way inside the sheeting arrangement in that section in which pipes are inserted. Working cylinders are arranged inside the sheeting only in the region of the cutting shoe, that is to say of the cutting shoe jack. However, said working cylinders lie outside that section in which the pipes have to be inserted. Therefore they do not get in the way there.

In a further configuration, provision is made for the sheeting panel wall to consist of a plurality of sheeting panels connected to one another in an articulated manner, and for the individual sheeting panels to be capable of being moved in a monitored and controlled manner via the integrated working cylinders.

In an especially advantageous configuration, it is specified that the sheeting panels are provided with injection openings for introducing lubricants between shaft/earth and sheeting-panel outer wall by means of a lubricant metering device which delivers said lubricants through the injection openings in a metered manner as a function of the determined control pressures, necessary for the advance, of the working cylinders. The point at which the advance becomes more difficult can then be detected within the control system. This is automatically detected when an increase in the hydraulic power is determined. However, if the increase in the power required for the advance remains within the tolerance, the injection openings in the sheeting panels are at least activated automatically and lubricant or clay powder is metered and injected to a greater or lesser degree. That is to say that, if the advance becomes troublesome, more lubricant is metered, and, if the advance becomes easier again, less lubricant is metered. The lubricant metering is thus directly related to the expenditure of energy determined from the pressure/displacement correlation measurement. This is because, before the sheeting machine is stopped too early on account of pronounced jamming of the sheeting in the shaft, the control system automatically attempts to reduce the friction forces by increased addition of lubricant. This operation may also take place fully automatically via said control unit.

The use of clay powder as lubricant in an apparatus or a method of claims 1 to 5 is in this case excellent, as has been found in practice. Said lubricant is especially advantageous in connection with the sheeting feed, since the requisite abutment forces for the advance continue to be reduced as a result.

An especially advantageous configuration already stated above is the integration of the cylinders for the sheeting feed in the wall of the sheeting panels. This immediately has a number of important advantages. Firstly, this results in a marked increase in the inner clearance width between the sheeting panels, in contrast to the prior art, where these cylinders are arranged or project inside the laying space in the sheeting, which impairs the insertion of the pipes.

In order to direct the pipes to be inserted past the cylinders in apparatuses from the prior art, the sheeting has to be correspondingly wide.

In the present apparatus according to the invention, however, the clearance width can be minimized to the pipe diameters to be laid. As a result, the apparatus according to the invention is narrower than apparatuses of known type. The consequence of this in turn is that less earth has to be moved, since the apparatus according to the invention is markedly narrower. Less earth movement means less expenditure of energy, less expenditure of time and thus lower costs.

Due to the integral arrangement of the hydraulic cylinders in the wall of the sheeting or of the sheeting machine, the cylinders are protected to a markedly greater degree and are thus less susceptible to faults and they are no longer damaged by the pipes to be inserted. In addition, their abutment relative to the respective sheeting panel is integrated in the wall, as a result of which said abutment is no longer at risk of fracture. In addition, there are no longer any tilting or lever forces on the abutment, since the hydraulic cylinders have their abutment directly inside the sheeting panel. Thus higher hydraulic forces can be introduced. The sheeting machine can thus be moved more effectively in hard subsoil. The sheeting machine can also be moved more quickly by higher hydraulic forces. Here, too, the installation becomes quicker again and the laying of pipes thus becomes more cost-effective.

Furthermore, an advantageous configuration consists in the fact that openings for the connection of water-pumping means are provided in the sheeting panels and/or in the cutting shoe and/or in the sheeting base. This likewise also applies to the add-on sheeting panels. Surface water or groundwater which could not be pumped off with other separate pumps can be pumped off via these openings.

An advantageous interaction between the procedure according to the invention, in which the resistance or alternating resistance in the subsoil can be determined via the cylinder pressures, now also occurs. Due to the integral type of construction of the hydraulic cylinders in combination with this sensory mode of operation, the pressure measurements are therefore especially suitable for detecting subsoil and earth density, since angled abutments, at which bending moments may distort the result, are no longer provided for the cylinders. Due to the direct action of force on the sheeting panel, differences in friction force can also be correspondingly measured and taken into account directly at the sheeting tip.

In addition to the fact that the installation automatically stops or changes over from automatic operation to manual operation if a pressure limit is exceeded, it is also possible in this connection to steer the sheeting machine during the cutting process. Although steering of the cutting shoe has been known hitherto, the maneuverability of sheeting of linked construction is novel and is essentially otherwise completely different from only steering the cutting shoe. The cutting movements of the sheeting and of the cutting shoe are always compared with one another in a correlative manner. That is to say that, if deviations from the section occur, the working cylinders are immediately activated automatically in such a way that they compensate for or modulate said deviations, or else stop the machine.

The apparatus is shown in the drawing and explained in more detail below.

In the drawing:

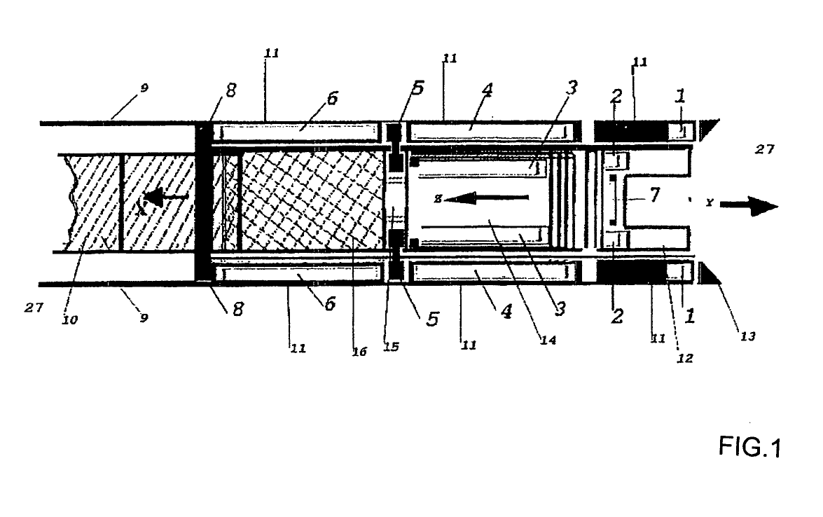

FIG. 1 shows an apparatus (sheeting machine) in plan view,

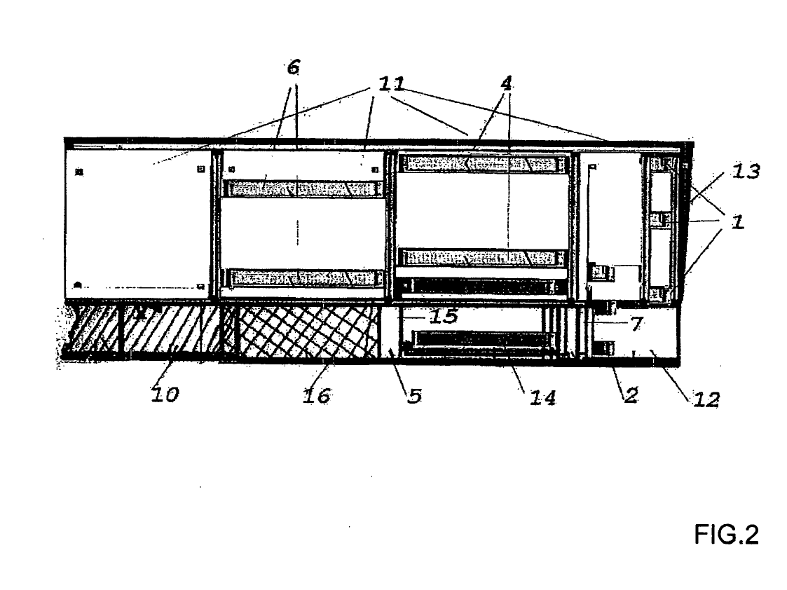

FIG. 2 shows FIG. 1 in side view,

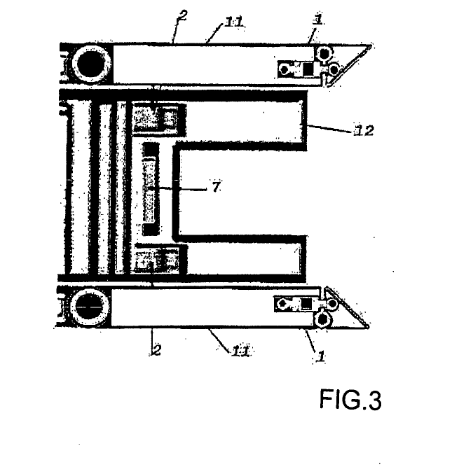

FIG. 3 shows a plan view of the cutting head,

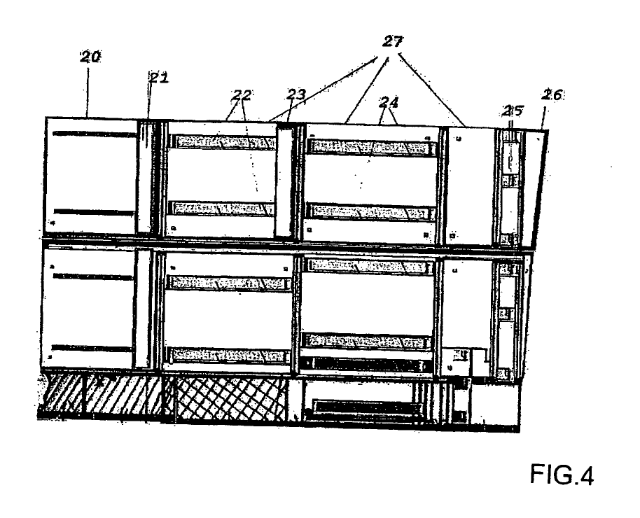

FIG. 4 shows a side view of the add-on sheeting machine,

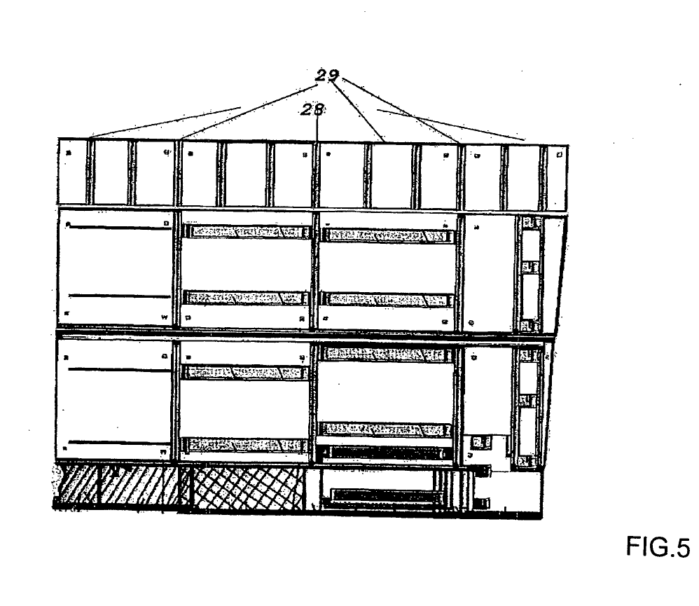

FIG. 5 shows the add-on sheeting machine,

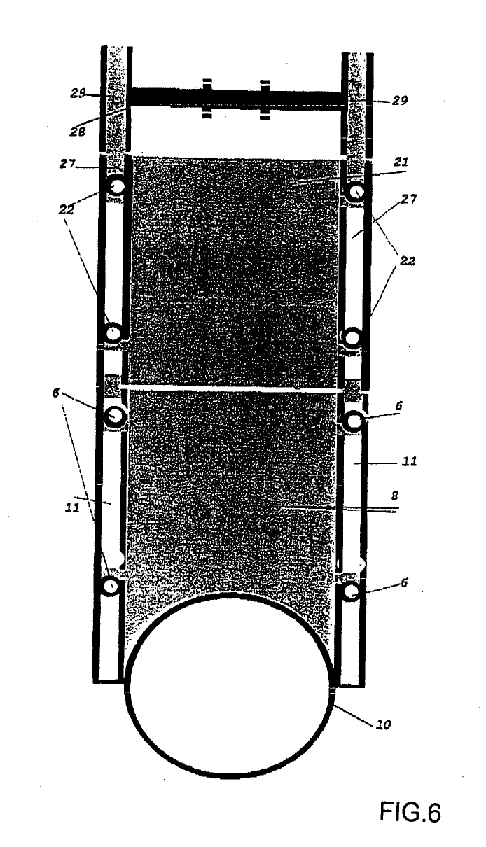

FIG. 6 shows a front view of the compacting plate,

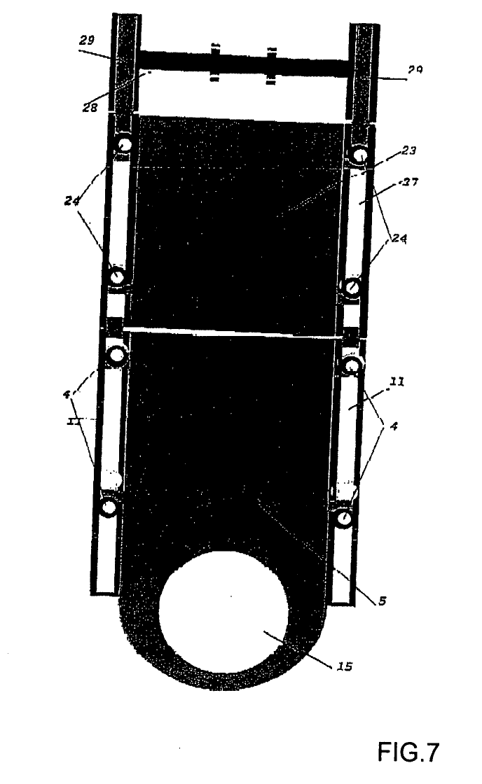

FIG. 7 shows a front view of the thrust plate,

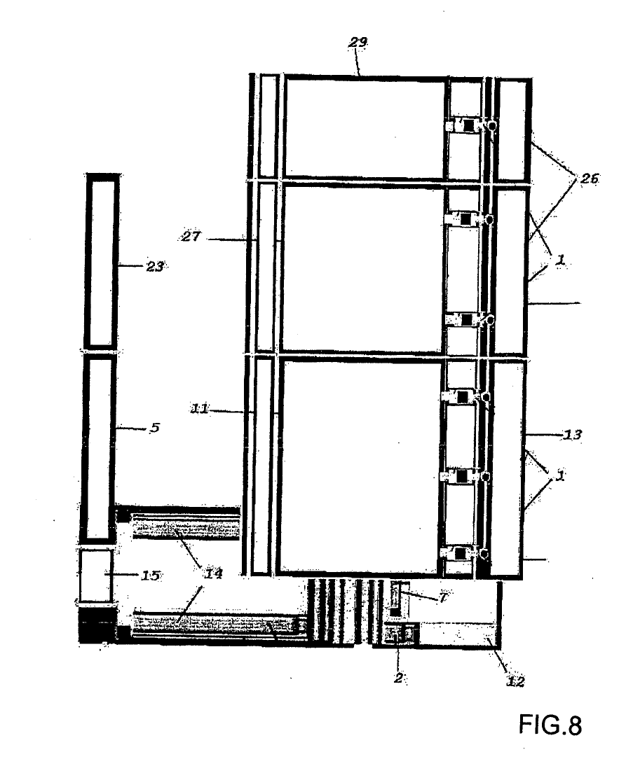

FIG. 8 shows a further partial side view,

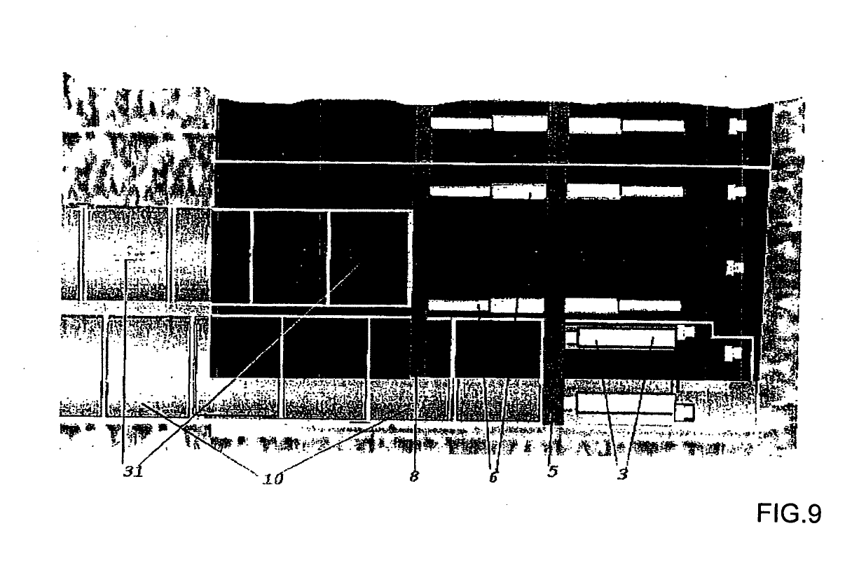

FIG. 9 shows a side view with laying of twin pipes one above the other,

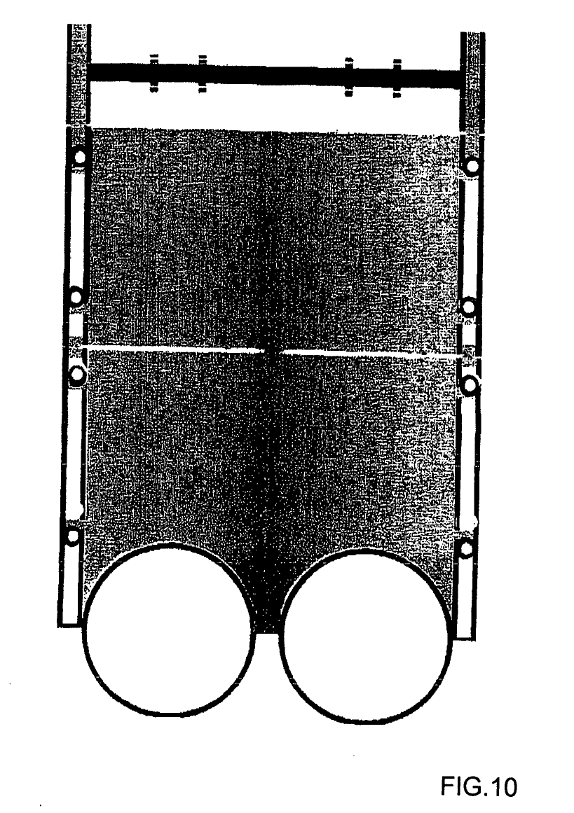

FIG. 10 shows a front view of the compacting plate with laying of twin pipes side by side,

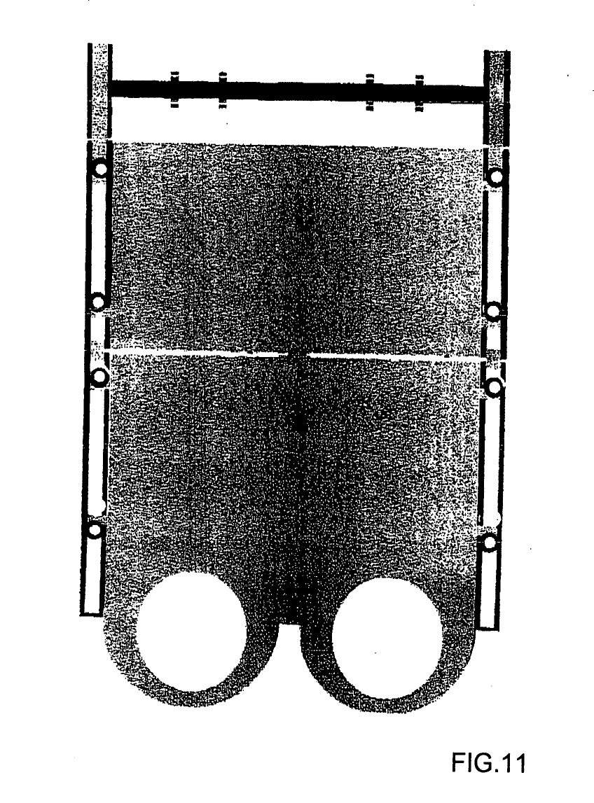

FIG. 11 shows a front view of the pressure and thrust plate with laying of twin pipes side by side.

FIG. 1 shows the most important components in plan view, i.e. from above into the sheeting machine. Hollow-body sheeting panels 11 connected to one another in an articulated manner run on the two sides. Hydraulic working cylinders 1, 4, 6 are arranged in an integrated manner inside said hollow-body sheeting panels 11. That is to say that these working cylinders run inside the sheeting panel wall and not, as in known arrangements, inside the interior space, formed by the sheeting panels, of the sheeting machine. Due to the integration in the sheeting panel wall, the entire space formed by the sheeting panels is unobstructed for the insertion of the pipes and the moving of the compacting plate and the thrust plate. No working cylinders or retaining angles of the same get in the way there. As a result, it is possible for the sheeting interior space to be designed to be very slim and very close to the pipe size to be laid. Thus markedly less earth has to be moved, as a result of which the installation is faster than known installations.

Furthermore, due to the integration of the working cylinders in the sheeting panels, the forces can be introduced without tilting moments and therefore in an optimum manner. Only the control cylinders 2 of the cutting shoe 12 and the hydraulic cylinders 3 of the cutting shoe jack 14 are arranged inside the cutting shoe 12 and the cutting shoe jack.

The thrust plate 5 and the compacting plate 8 are arranged between the lined-up sheeting panels 11. Said thrust plate 5 and said compacting plate 8 are actuated by the integrated working cylinders. The thrust plate 5 is actuated by the integrated cylinders 4, and the compacting plate 8 is actuated by the working cylinders 6, which cylinders extend upon actuation and either push the sheeting forward in segments or support it against the earth in an abutting manner, compact the earth at the same time and apply a force component which effects the advance of the sheeting. A further split abutting force component is produced by support on the already laid pipe. During the cutting operation by means of the cutting shoe, during which only the pipe contour to be laid is cut, distributed support in terms of force is also effected on the pipe and the earth. Further support during the cutting operation can be effected by the spreading of the sheeting panels inside the trench.

The cutting shoe is moved in direction Y, that is to say in the direction of advance. However, the cutting shoe jack 14, i.e. its working cylinder 3, travels rearward, that is to say in the Z direction indicated.

The compacting plate 8 is moved in the X direction of the pipes 10 already laid and compacts the earth poured in again there. That is to say the excavated material produced by the cutting shoe 12 and also by the cutting front sheeting panels is removed and poured in again at the rear. The sheeting machine therefore travels through the earth like a zip fastener.

The front edge of the front sheeting panels is provided with sheeting tip armor 13. In addition, the latter is beveled, such that not only the cutting shoe 12 but also the sheeting itself travel into the earth. That is to say that the trench section is cut.

Inside the sheeting machine, the sheeting base 16 can be seen in plan view in the section into which the pipes are inserted, said sheeting base 16 forming a base-side pipe half shell which accommodates the pipe to be laid.

Furthermore, in the cutting shoe 12 and also in the pressure and thrust plate 5, there are bulkhead partitions 7 and 15, respectively, which can be opened to allow accumulating water to pass through so that there is no water pressure on the sheeting machine.

Behind the compacting plate, the “trailing rear sheeting panels” are only designed as sheeting plates which form the compaction chamber.

FIG. 2 shows a side view of the sheeting machine according to the invention. On the base side, it can be seen that, below the sheeting panels 11, the sheeting base 16 projects at the bottom as a half shell approximately halfway up a concrete pipe 10 only over a section of the sheeting machine. Projecting in the section in front is the bottom part of the cutting shoe 12. This part digs through the earth in the lower region. In the region of the sheeting panels, the sheeting panels do the same. Part of the cutting shoe jack 14 can likewise be seen. The cutting shoe itself can be steered via control cylinders 2. In the region of the working cylinders 4 and 6 integrated in the sheeting panels, the latter are shown transparently so that the positioning of said working cylinders can be seen.

In the front region, the sheeting panels 11 are provided with armor 13 which keeps the front edge of the sheeting resistant and hard for cutting the sheeting into the earth during the sheeting advance and protects said front edge. This armor 13 serves as a cutting edge in the process.

FIG. 3 shows in detail only the cutting shoe 12 and the front sheeting panels 11 surrounding it. At the sheeting tip, i.e. directly behind the sheeting tip armor, there are small control cylinders 1, with which the sheeting tip can also be steered during the advance. The bulkhead partition 7, through which the accumulating water can be directed rearward, in the cutting shoe 12 can likewise be seen.

FIG. 4 shows the possibility of varying the sheeting vertically. To this end, add-on sheeting panels 27 are put onto the sheeting panels which can be seen from FIG. 2. The add-on sheeting panels 27 likewise contain integrated working cylinders 25, 24 and 23 and also the working cylinders integrated in the sheeting panels for actuating the add-on compacting plate 21 likewise extended upward and the add-on thrust plate 23.

Due to this extension of the construction upward according to the invention, pipe laying can be realized in which the trench is deeper or in which two pipelines can be laid simultaneously one above the other. The chronological actuation of the individual components has already been described above for the laying of two pipelines.

FIG. 5 shows further removable add-on panels 29, which become necessary when certain depth dimensions are to be achieved. These further add-on panels 29 certainly no longer contain any working cylinders but are stabilized via additional stiffeners 28.

FIG. 6 shows a section through the sheeting machine at the items shown in FIG. 1 with the item number 8. Item number 8 is the compacting plate, which is arranged behind the sheeting base 16 according to FIG. 1.

In this example according to FIG. 6, a sheeting machine is selected which already has add-on sheeting panels 27, as can be seen in FIG. 5 in side view. Consequently, a further compacting plate, an “add-on compacting plate” 21, is provided above the compacting plate 8 which lies at the bottom above the pipe contour of the pipe 10 to be laid. Said add-on compacting plate 21 is actuated via the working cylinders integrated in the sheeting panels 11, 27 and compacts the earth which is poured in again at the rear and which at the same time also serves as a partial abutment for the entire advance.

Here, too, the add-on sheeting panels 29 can likewise be seen, which are required, for example, for underpinning obstacles. Before the hydraulically advanced sheeting is moved through under the obstacle, the add-on sheeting panels are removed and are put on again after passing the obstacle.

FIG. 7 shows a section through the sheeting machine in the region of the pressure and thrust plate 5, which, as can be seen above and as has been described above, is guided in the sheeting and is suspended therein. Said pressure and thrust plate 5 is likewise actuated by the working cylinders integrated in the sheeting panels and the add-on sheeting panels. In the lower region, this pressure and thrust plate 5 has a through-opening 15 for the pipe to be laid. In this case, the entire pipe contour is enclosed at the pressure and thrust plate, since the cutting shoe is positioned in front of it.

FIG. 8 shows the relative mobility of the front sheeting panel region lying in front of the pressure and thrust plate 5.

FIG. 9 shows the simultaneous laying of two pipelines in a snapshot of a sheeting machine in action. It is important to note here that the two pipelines can be laid very exactly and even at an appropriate vertical distance from one another. The laid pipes therefore do not lie directly on top of one another but rather at a distance apart and embedded securely in the earth.

FIG. 10 shows the front view of the compacting plate when laying twin pipes side by side. In this case, it becomes clear that only a joint compacting stroke is necessary when laying twin pipes side by side. In this respect, FIG. 11 shows the front view of the corresponding pressure and thrust plate during this laying of twin pipes side by side. Here, too, only a single joint working stroke becomes necessary.

### LIST OF DESIGNATIONS

1. Integrated working cylinders for controlling the sheeting
2 Control cylinders of the cutting shoe
3 Hydraulic cylinders for cutting shoe jack
4 Integrated working cylinders for actuating the thrust and pressure plate
5 Pressure and thrust plate
6 Integrated working cylinders for actuating the compacting plate
7 Cutting-shoe bulkhead partition
8 Compacting plate
9 Sheeting plates of the compaction chamber
10 Already laid concrete pipes
11 Hollow-body sheeting panels
12 Cutting shoe
13 Sheeting tip armor
14 Cutting shoe jack
15 Bulkhead partition of the pressure and thrust plate
16 Sheeting base
17 Earth compaction direction X
18 Advance direction Y
19 Extension direction Z of cutting shoe jack
Note: The directions X, Y and Z are in this case not the orthogonal Cartesian coordinate directions, but rather directions according to the drawing.
20 Sheeting plates of the add-on compaction chamber
21 Add-on compacting plate
22 Working cylinders for add-on compacting plate
23 Pressure and thrust plate of the add-on sheeting panels
24 Working cylinders for actuating the pressure and thrust plate of the add-on sheeting panels
25 Working cylinders for the sheeting control of the add-on sheeting panels
26 Sheeting tip armor of the add-on sheeting
27 Add-on sheeting panels
28 Sheeting stiffeners
29 Removable add-on panels
30 Earth
31 Second laid pipeline

1-17. (canceled)

18. A method of laying conduit pipes in earth with follow-on sheeting, which comprises the steps of:
driving a laying shaft into the earth;
inserting through sheeting to be advanced and the conduit pipes one after another;
refilling the laying shaft behind the sheeting;
measuring and recording one of feed forces and hydraulic pressures of working cylinders disposed on a cutting shoe and inside the sheeting in relation to a mounting position of each working cylinder of a sheeting machine;
comparing the pressures between a left-hand sheeting side and a right-hand sheeting side; and
in an event of asymmetry outside a predeterminable tolerance of a comparison, performing one of automatically stopping an advance movement of the sheeting machine and automatically initiating correction control of the sheeting machine.

19. The method according to claim 18, which further comprises determining a density asymmetry of the earth during the advance movement by a correlation of a hydraulic pressure measurement and a displacement measurement such that operating forces optimized as a result are determined and modulated for the respective working cylinders of the cutting shoe and of the sheeting.

20. The method according to claim 18, which further comprises inside the sheeting, controlling the cutting shoe for cutting a following pipe contour on a base side both together with the sheeting and independently of the sheeting.

21. The method according to claim 20, which further comprises:
detecting a position of transversely running obstacles from a predeterminable distance from the sheeting machine by use of sensors at an advance-side tip of the sheeting; and
automatically stopping the sheeting machine when the position is accordingly determined.

22. The method according to claim 18, which further comprises laying two pipes lying one above another by the steps of:
inserting a bottom pipe into a space between a pressure and thrust plate up to a pipe possibly already laid beforehand;
inserting a top pipe directly above the bottom pipe up to a another top pipe possibly laid beforehand; and
pouring the earth again by first being pushed together around the bottom pipe by a bottom compacting plate and then by the earth being pushed together around and above the top pipe by a top compacting plate.

23. The method according to claim 18, which further comprises laying two pipes lying side by side by being placed one after another or at a same time into the sheeting machine and thus into a laying pit, and by the earth being pushed together over the two laid pipes in a joint stroke of a compacting plate.

24. The method according to claim 18, which further comprises providing sewage pipes as the conduit pipes.

25. A sheeting machine for laying conduit pipes in earth, the sheeting machine comprising:
the sheeting machine configured for:
driving a laying shaft into the earth;
inserting through sheeting to be advanced and the conduit pipes one after another; and
immediately refilling the laying shaft behind the sheeting;
the sheeting machine containing:
a cutting shoe;
working cylinders disposed on said cutting shoe inside the sheeting;
a control device having sensors for measuring one of feed forces and hydraulic pressures, necessary for advancement, of said working cylinders, and electronically recorded in said control device in relation to an installation position of each of said working cylinders, and pressures between a left-hand sheeting side and a right-hand sheeting side are compared, and in an event of asymmetry outside a predeterminable tolerance, one of an advance movement of the sheeting machine is automatically stopped and correction control is automatically initiated.

26. The sheeting machine according to claim 25, wherein a density asymmetry in the earth during the advancement is calculated by a correlation of a hydraulic pressure measurement and a displacement measurement inside said control device, and the displacement measurement is effected via one of optical, resistive and acoustic sensors.

27. The sheeting machine according to claim 25, further comprising at least one thrust/compacting plate for abutting support during the advancement and being hydraulically movable, said thrust/compacting plate being movable forward and backward inside the sheeting machine by said working cylinders.

28. The sheeting machine according to claim 27, further comprising at least one hydraulically movable pressure and thrust plate for partial abutting support during the advancement on an already laid pipe section and disposed inside the sheeting machine, said pressure and thrust plate being movable forward and backward via said working cylinders inside the sheeting.

29. The sheeting machine according to claim 25, further comprising a bulkhead partition which can be opened and is integrated inside said cutting shoe.

30. The sheeting machine according to claim 27, further comprising a bulkhead partition which can be opened and integrated inside said thrust/compacting plate.

31. The sheeting machine according to claim 25, further comprising a sheeting panel wall and at least some of said working cylinders are disposed so as to be integrated inside said sheeting panel wall.

32. The sheeting machine according to claim 31, wherein said sheeting panel wall is formed of a plurality of sheeting panels connected to one another in an articulated manner, and in that individual ones of said sheeting panels can be moved in a monitored and controlled manner via said working cylinders.

33. The sheeting machine according to claim 32,
further comprising a water-pumping means;
further comprising a sheeting base;
wherein at least one of said sheeting paneling, said cutting shoe and said sheeting base has openings formed therein for a connection to said water-pumping means.

34. The sheeting machine according to claim 32,
further comprising a lubricant metering device; and
wherein said sheeting panels have injection openings formed therein for introducing lubricants between the earth and an outer wall of the sheeting panels by said lubricant metering device delivering the lubricants through said injection openings in a metered manner as a function of determined control pressures, necessary for the advance, of said working cylinders.

35. The sheeting machine according to claim 34, wherein said lubricant metering device provides a clay powder as a lubricant.

36. The sheeting machine according to claim 25, wherein the sheeting machine is configured for laying sewage pipes.
